(19) United States
(12) Patent Application Publication
(10) Pub. No.: US 2022/0087280 A1
(43) Pub. Date: Mar. 24, 2022

(54) DARK COCOA POWDER

(71) Applicant: CARGILL, INCORPORATED, Wayzata, MN (US)

(72) Inventors: Vincent Schoot UITERKAMP, Haarlem (NL); Jan Pieter Hubert VAN IERSEL, Haarlem (NL)

(73) Assignee: CARGILL, INCORPORATED, Wayzata, MN (US)

(21) Appl. No.: 17/426,087

(22) PCT Filed: Feb. 3, 2020
(86) PCT No.: PCT/US2020/016353

§ 371 Date: Jul. 27, 2021

(30) Foreign Application Priority Data
Feb. 6, 2019 (EP) 19155686.9

(51) Int. Cl. A23G 1/00

(52) U.S. Cl. CPC A23G 1/0016

(57) ABSTRACT

The invention relates to a continuous process for producing a dark cocoa powder, comprising: mixing a cocoa product with water in an amount of up to 50% by weight, based on the total weight of the mixture; heating the cocoa product and the water to a temperature of 90-160° C. until a moisture content of 5% by weight, based on the total weight of the mixture, or less is achieved; and recovering a cocoa powder; wherein the cocoa powder recovered in step (d) has an L value which is lower than that of the cocoa product of step (a). The invention further relates to cocoa powders produced by this method and to their use in food or beverage compositions.

### CROSS-REFERENCE TO RELATED APPLICATIONS

This application claims the benefit of European Patent Application No. 19155686.9, filed Feb. 6, 2018, entitled DARK COCOA POWDER, which is hereby incorporated by reference herein in its entirety

### FIELD OF THE INVENTION

The present invention relates to a method of producing dark cocoa powder, to dark cocoa powders obtainable by this method, and to food and beverage compositions comprising such materials.

### BACKGROUND OF THE INVENTION

Processing of cocoa beans typically involves one or more standard steps including, for example, fermentation, de-hulling, and roasting. A de-hulled cocoa bean is called a cocoa nib. Nibs are crushed and/or milled to produce cocoa liquor (or cocoa mass) which, in turn, may be pressed to produce cocoa butter, leaving a substantially defatted cocoa cake (or press-cake). The cake can then be more finely ground to produce cocoa powder. The color and flavor of the cocoa powder may be adjusted through alkalization—the process of heating cocoa nibs in the presence of an alkalizing agent—resulting in alkalized or “clutched” cocoa powder. Alkalized cocoa powders are typically darker than their equivalent non-alkalized powders.

The color of cocoa powders can be expressed using the Hunter color coordinate scale or CIE 1976 (CIELAB) color system which uses three coordinates (or values) to define a powder's color profile. The L coordinate represents brightness and can assume values between 0 (for black) and 100 (for white); the a value represents the red component (a>0); and the b value represents the yellow component (b>0). An example of how to measure these values is described under Methodology below. The L value for non-alkalized cocoa powders is typically 20 or more; for slightly alkalized powders, it goes down to between 16 and 20; and for highly alkalized powders, it tends to be between 13 and 16. The alkalization process, and variations thereof, are described in U.S. Pat. Nos. 4,435,436, 4,784,866 and 5,009,917, and in European Patent No. 2068641.

The darker color of alkalized cocoa powders is considered highly desirable and, as such, there has been a trend in the industry for more and more intense alkalization. Unfortunately, however, too strong alkalization can also negatively impact flavor. There is therefore a need, in the market, for dark cocoa powders with both a desirable color profile, and a less alkaline, more desirable flavor profile.

EP3013153 discloses an alkalization-free method of producing a dark cocoa product comprising mixing cocoa nibs and/or beans with water, heating to 89-115° C. at pressures of 5-22 psi, drying and grinding the product. The resulting products have an L value of 11.24-14.52, corresponding to mild alkalization levels.

Thus, there remains a need for a method of producing truly dark cocoa powders (with L values of 11 or lower) while maintaining a desirable flavor profile.

### STATEMENTS OF THE INVENTION

In one aspect of the present invention, there is provided a continuous process for producing a dark cocoa powder, comprising:

mixing a cocoa product selected from cocoa cake and/or cocoa powder with water in an amount of up to 50% by weight, based on the total weight of the mixture;
heating the cocoa product and the water to a temperature of 90-160° C. until a moisture content of 5% by weight, based on the total weight of the mixture, or less is achieved;
optionally grinding the dried cocoa product; and recovering a cocoa powder;
wherein the cocoa powder recovered in step (d) has an L value which is lower than that of the cocoa product of step (a).

In another aspect of the present invention, there is provided a cocoa powder obtainable according to the above method, preferably with a reduced L value (relative to the L value of the starting material). It will advantageously have an L value below 20, preferably of 11 to 17, and an a/b value of 0.9 to 1.5.

In yet another aspect of the present invention, there is provided a food or beverage product comprising the above cocoa powder.

Further aspects of the present invention are recited below and in the claims attached hereto.

### DETAILED DESCRIPTION OF THE DRAWINGS

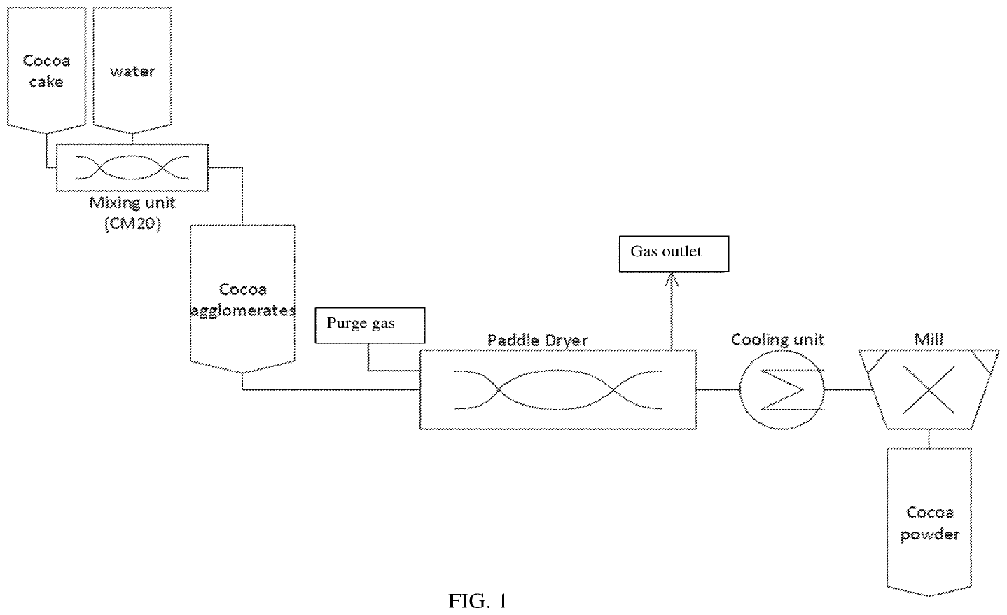

FIG. 1 illustrates an aspect of the equipment set up for processing cocoa cake particles to obtain cocoa powder.

### DETAILED DESCRIPTION

The present invention provides a continuous process for producing a dark cocoa powder, comprising:

a) mixing a cocoa product selected from cocoa cake and/or cocoa powder with water in an amount of up to 50% by weight, based on the total weight of the mixture;
b) heating the cocoa product and the water to a temperature of 90-160° C. until a moisture content of 5% by weight, based on the total weight of the mixture, or less is achieved;
c) optionally grinding the product of step (b); and
d) recovering a cocoa powder;
wherein the cocoa powder recovered in step (d) has an L value which is lower than that of the cocoa product of step (a).

### Cocoa Product

The cocoa product used in the process of the present invention is selected from cocoa cake and/or cocoa powder. The terms cocoa cake and cocoa powder, as used herein, will have their normal meaning and may be produced by any methods known in the art (as illustrated above). They may be obtained from beans of any origin, which have been sterilized or not, and with any degree of fermentation (including under-fermented and unfermented beans). They may be of any type known to the skilled person. For instance, they may be high-fat cocoa products, with more than 12%, typically about 20-25%, cocoa butter by weight; standard cocoa products, with 10-12% cocoa butter by weight; or a low-fat or fat-free cocoa products, with less than 10% cocoa butter or less than 2% cocoa butter by weight, respectively. Advantageously, the cocoa product will be a standard or low-fat cocoa product, most preferably a low-fat cocoa product.

In one aspect, the cocoa product used in the process of the invention will be in the form of agglomerates. Agglomeration occurs when wet or “sticky” particles are brought into contact with each other and a liquid bridge is formed between them. The agglomerated particles are then dried (or cooled) and the bridge is solidified. Suitable methods of agglomerating cocoa particles are well known in the art. They include steam agglomeration, thermal agglomeration, wet agglomeration with high shear mixing, and fluidized bed agglomeration, amongst others.

Preferably, the cocoa products used in the process of the invention will be roasted cocoa products, that is cocoa cake and/or cocoa powder obtained from beans and/or nibs that have been roasted. Roasting is a standard processing step in the production of cocoa products and may be performed using any means and to any degree known to a person skilled in the art. For example, roasting may have been performed by heating beans/nibs to 100 to 125° C. for about 60 min.

The cocoa products may also be alkalized. Alkalized cocoa products are ones that have been treated with an alkalizing agent prior to being used in the process of the present invention, using any alkalizing agent and any alkalizing process known to the skilled person. The cocoa products may themselves have been alkalized, or they may be obtained from cocoa beans, cocoa nibs and/or cocoa liquor which has been alkalized.

In some aspects of the present invention, however, the cocoa products will not be alkalized or will only be lightly alkalized. It is indeed an advantage of the process of the invention that it can be used to obtain cocoa products with darker, more intense color profiles (compared to equivalent products not processed according to the invention). As such, it can be used on alkalized cocoa products (either before or after alkalization) to obtain extra-dark cake and/or powder, or it can be used on non-alkalized products to obtain colors equivalent to standard or typical alkalized products without any of the disadvantages of alkalization.

The process of the present invention is a continuous process, meaning that there is a substantially continuous flow of product through the reactor(s). The term “continuous” is used herein to differentiate the process from batch-style processes. Advantageously, the process may be performed at atmospheric pressure.

Mixing with Water

In a first step of the process of the present invention, the selected cocoa product is mixed with water in an amount of up to 50% water by weight, preferably of 10 to 50% water by weight, based on the total weight of the mixture. Preferably, water will be added in an amount sufficient to achieve a moisture content, of the cocoa product, of 10 to 50% by weight, more preferably of 15-40% by weight, more preferably of 20-35% by weight, based on the total weight of the cocoa product. By way of illustration, cocoa particles or cocoa powder may be mixed with water to produce agglomerates with a moisture content of up to 50%, preferably of 15-40%, more preferably of 20-35%, more preferably of 20-30% by weight.

Preferably, the mixture will be substantially free of alkali (and ideally entirely free of alkali). It is indeed an advantage of the present invention that it can be used to obtain the effect of alkalization without any alkalization steps.

### Heating

The mixture of step (a) is heated to a temperature of 90-160° C. and this temperature is maintained until a moisture content of 5% or less by weight, based on the total weight of the mixture, is achieved. Preferably, the mixture is heated to a temperature of 100-150° C., more preferably of 110-150° C., more preferably of 110-130° C. This temperature refers to the target temperature of the cocoa product, and is measured as the average temperature of the cocoa product once a stable temperature has been reached. Heating may be achieved by any means available to the skilled person. For example, it may be achieved through injection of hot air or steam into the reactor, and/or through contact heating, e.g. with heated reactor walls. The mixture of cocoa product and water may also be pre-heated prior to the heating step (e.g. through the use of hot water), allowing it to reach the target temperature more rapidly.

Advantageously, heating will be performed under continuous agitation. As used herein, the term “continuous agitation” refers to the fact that the mixture of cocoa product and water will be agitated (by any means available, e.g. tumbling, shaking, stirring, rotating, etc.) either constantly or at intervals throughout the heating step in order to obtain more homogeneous heating and drying. For example, heating may be performed in a reactor equipped with agitation means. Suitable agitation means may include paddles or blades disposed about a rotating shaft along the length of the reactor. They will serve both to move the mixture along the length or the reactor, from inlet to outlet, and to continuously agitate the mixture for more even heating.

The heating step may be performed in any kind of reactor or vessel. Preferably, it will be performed in a reactor through which a stream of gas is passed. Preferably, the heating step will be performed under continuous gas flow. By “continuous gas flow” it is meant that gas is able to enter and exit the reactor throughout the heating step, preferably at a substantially constant rate. Airflow will be expressed in ml/min per kg of cocoa product (ml/min/kg). Ideally, the airflow will be at least 50 ml/min/kg, preferably between 100 and 4000 ml/min/kg, more preferably between 250 and 2000 ml/min/kg, more preferably between 500 and 1000 ml/min/kg. The exact rate will be determined by the skilled person based on standard practice and the desired characteristics of the end product. The gas may be any gas suitable for use in the manufacture of foods, such as air or, preferably, nitrogen. Advantageously, the gas will not be oxygen or an oxygen-rich gas.

Indeed, the heating step is preferably performed in an oxygen-reduced atmosphere, and even more preferably an oxygen-free atmosphere. For example, it may be performed in a nitrogen atmosphere. This is particularly advantageous when using cocoa products with higher fat contents where reactions with oxygen may negatively impact flavor.

The heating step may last for up to 120 minutes, or be as short as 30 minutes. Preferably, it will last for 40 to 100 minutes, more preferably for 45 to 80 minutes, most preferably for 45 to 60 minutes. Once completed, heating (together with any airflow and agitation) will typically be interrupted, and the dried cocoa product recovered.

### Grinding & Optional Processing

The recovered cocoa product may then be further processed to obtain the desired end product. For example, if the cocoa product used as starting material is a cocoa cake, it may be further ground to obtain a cocoa powder.

Other processing steps that may be included in the process of the invention will be apparent to a person skilled in the art (such as tempering if needed). Advantageously, however, the process will not include any alkalization steps.

Cocoa powder and/or cocoa cake obtainable according to the above process are also part of the present invention.

### Color

The cocoa product recovered at the end of the process of the present invention (i.e. in step (d)) has an L value which is lower than that of the cocoa product used as a starting material (i.e. in step (a)).

As noted above, a lower L-value indicates a darker—or “higher impact” cocoa product, with non-alkalized cocoa products typically having an L-value of 20 or more; slightly alkalized products having an L-value of between 16 and 20; and highly alkalized products typically having an L-value of between 13 and 16.

Preferably, the L value of the cocoa product of step (d) will be 0.5 to 10 points lower than that of the cocoa product of step (a). If the cocoa product of step (a) is an alkalized cocoa product, the L value in step (d) will advantageously be 2 to 4 points lower than that of the cocoa product of step (a). If the cocoa product of step (a) is a non-alkalized cocoa product, the L value in step (d) will advantageously be 4 to 7 points lower than that of the cocoa product of step (a). This increase in darkness or impact is advantageously achieved without any alkalization steps being included in the process of the invention, and therefore without any of the disadvantages of alkalization.

According to a further advantage of the process of present invention, the cocoa product recovered in step (d) will have a lower a/b value than that of the cocoa product used in step (a). The a/b value of the product of step (d) may be 0.1 to 1 points lower than that of the cocoa product of step (a), and typically about 0.2-0.5 points lower.

Advantageously, cocoa products obtainable according to the process of the present invention, if starting from an alkalized cocoa product, will have an L-value of less than 12, preferably of 7 to 11, and an a/b-value of 0.9-1.6; if starting from a non-alkalized cocoa product, the obtained cocoa products will advantageously have an L-value of less than 18, preferably of 11 to 17, such as an L-value of 14 to 16, and an a/b-value of 0.9-1.6.

Normally, to produce true high impact cocoa powders, the degree of alkalization typically required results in a high pH and an undesirable, alkaline flavor profile. Advantageously, with the method of the present invention, it is possible to produce dark or high impact cocoa powders with much lower alkalinity, since no or less alkalization is required, and therefore with improved flavor relative to alkalized cocoa powders or equivalent darkness. Thus, the cocoa products of the present invention preferably have a pH of less than 9.0, more preferably of less than 8.0, more preferably of less than 7.0, more preferably of less than 6.5. Specifically, high impact cocoa products of the present invention, produced from alkalized cocoa products as starting materials will preferably have a pH of 6 to 9, while products obtained from non-alkalized cocoa products as starting materials will have a pH of about 5.5 to 6.5. High impact or dark cocoa powders with non-alkaline or reduced alkaline flavor are also part of the present invention.

In a further advantage, the high impact cocoa products of the present invention may have a low ash content, lower than traditional alkalized or high impact cocoa powders. They will preferably have an ash content of less than 15 FFDM, more preferably of 10 to 14 FFDM.

The cocoa products obtained according to the method of the present invention can be used on their own or mixed with other cocoa products to produce food and beverage compositions with tailored color and flavor profiles. Advantageously, the high impact cocoa products of the invention can also be used to decrease costs or increase margins, since smaller quantities can be used to achieve the same color impact as larger quantities of standard cocoa products. Thus, the present invention also provides food and beverage compositions comprising high impact cocoa products obtainable according to the process described herein. These may include, by way of illustration only, milk, dark, and white chocolate and compound compositions (for use, amongst others, in confectionary, as bars, in truffles and pralines, or as inclusions, coatings, or fillings), drinking chocolate, flavored milks (dairy and non-dairy), flavored syrups, bakery products (such as cakes, cookies and pies), diet bars and meal substitutes, sports and infant nutrition, ice-cream products, dairy products, puddings, mousses, sauces, and breakfast cereals. Methods of manufacturing these food and beverage compositions are also part of the present invention.

Various embodiment of the present invention will now be described by way of the following examples which are provided for illustration purposes only and are not intended to be limiting.

### EXAMPLES

### Example 1

Cocoa cake particles (available from Cargill under product name GT78) with a particle size of 0.1 to 30 mm were mixed with water in a high intensity mixer (Loedige CM20) to produce cocoa agglomerates with the desired moisture content (see Table 1).

The cocoa agglomerates where then dried with a paddle dryer, under atmospheric pressure, to a moisture content of 5% or less (gas is purged for evaporation as part of the drying process). The dried agglomerates are allowed to cool to around 60° C. before being milled to produce cocoa powder (with an average particle size of 0.1-5 mm). The equipment set-up is illustrated in FIG. 1.

TABLE 1
Process parameters

| | Moisture content | Residence | Temperature cocoa |
|---|---|---|---|
| | cocoa agglomerates | time in the | agglomerates end |
| | (after mixing) | dryer (min) | dryer (° C.) |
| Series 1A | 20 | 90 | 110 |
| Series 1B | 30 | 45 | 140 |

TABLE 2
Resulting cocoa powder color after cooling and milling

| | L | a | b | a/b |
|---|---|---|---|---|
| Start Material | 13.0 | 7.6 | 4.7 | 1.63 |
| Series 1A | 12.5 | 7.2 | 5.0 | 1.45 |
| Series 1B | 12.0 | 6.9 | 4.5 | 1.54 |

The cocoa powder obtained according to the above method has an L value which is lower than that of the original cocoa cake particles despite not being treated with any alkali.

### Example 2

Natural cocoa cake particles (available from Cargill under product name Gerkens 10/12 NA55) with a particle size of 0.1 to 30 mm were mixed with water in a high intensity mixer (Loedige CM20) to produce cocoa agglomerates with the desired moisture content (see Table 3).

The cocoa agglomerates where then dried with a paddle dryer, under atmospheric pressure, to a moisture content of 5% or less (gas is purged for evaporation as part of the drying process). The dried agglomerates are allowed to cool to around 60° C. before being milled to produce cocoa powder (with an average particle size of 0.1-5 mm). The equipment set-up is the same as for Example 1.

TABLE 3
Process parameters

| | Moisture content | Residence time | Temperature cocoa |
|---|---|---|---|
| | cocoa agglomerates | in the | agglomerates end dryer |
| | (after mixing) | dryer (min) | (° C.) |
| Series 2 | 20 | 45 | 110 |
| Series 3 | 30 | 90 | 110 |
| Series 4 | 20 | 45 | 140 |
| Series 5 | 30 | 90 | 140 |

TABLE 4
Resulting cocoa powder color after cooling and milling

| | L-value | a-value | b-value | a/b-value |
|---|---|---|---|---|
| Start material | 21.65 | 10.5 | 10.9 | 0.96 |
| Series 2 | 19.5 | 9.0 | 8.4 | 1.06 |
| Series 3 | 19.0 | 8.7 | 8.1 | 1.08 |
| Series 4 | 18.7 | 8.8 | 8.1 | 1.08 |
| Series 5 | 17.5 | 8.3 | 7.5 | 1.11 |

The cocoa powder obtained has an L value which is lower than that of the original cocoa cake particles despite not being treated with any alkali.

### Methodology

All color values measured in the above examples were measured according to the following methodology.

Color values are expressed as Hunter L, -a and -b values, where the L value represents the “darkness” of the product (black/white scale), the “a” value represents the amount of green/red and the “b” value represents the amount of yellow/blue. The quotient of “a” over “b” represents the redness of the product. The following procedure was used to determine the color values of specific cocoa powders.

### Instruments and Reagent

Balance correct up to 0.01 gram

100 ml beaker

Stirring rod

Measuring cylinder (25 ml)

Optically neutral petridish (Brand: Sterilin)

Spectrocolorimeter Hunterlab Colorquest, use Illuminant C and 2° standard observer, read values in Hunter L, -a and b values.

Calibration tile black, as present with instrument

Calibration tile white, as present with instrument

Reference cocoa powder sample with known color values

Tap water, temperature range 50-60° C.

Thermometer

### Calibration Procedure

Calibration was done using the black and white calibration tiles provided with the Hunterlab color meter, following manufacturer's instructions.

### Color Measurement Method

5.00±0.01 gram cocoa powder was measured in a 100 ml beaker; 15.0 ml tap water of minimal 50° C. was added to the cocoa powder; the solution was directly stirred until a homogeneous slurry was obtained; the contents of the 100 ml beaker were then cooled to room temperature by letting it rest for 15 minutes; the contents of the beaker were then stirred again and the slurry without lumps was poured into the optically neutral petri dish; the L, a and b-values were then measured on the calibrated color meter—the Hunter L value are recorded to 1 decimal, the a and b values to 2 decimals and the a/b value is calculated and recorded to 2 decimals. Note: after calibration of the color meter, the reference sample was measured first to check matrix fluctuations, followed by non-reference samples.

1. A continuous process for producing a dark cocoa powder, comprising:
a) mixing a cocoa product selected from cocoa cake and/or cocoa powder with water in an amount of up to 50% by weight, based on the total weight of the mixture;
b) heating the cocoa product and the water to a temperature of 90-160° C. until a moisture content of 5% by weight, based on the total weight of the mixture, or less is achieved;
c) optionally grinding the product of step (b); and
d) recovering a cocoa powder;
wherein the cocoa powder recovered in step (d) has an L value which is lower than that of the cocoa product of step (a).

2. A process according to claim 1, wherein the cocoa product of step (a) is a roasted cocoa product.

3. A process according to claim 1, wherein the cocoa product of step (a) is an alkalized cocoa product

4. A process according to claim 1, wherein the cocoa product of step (a) is a non-alkalized cocoa product.

5. A process according to claim 1, wherein the cocoa product of step (a) is in the form of agglomerates.

6. A process according to claim 1, which does not include alkalization.

7. A process according to claim 1, wherein step (b) is performed under continuous agitation.

8. A process according to claim 1, wherein step (b) is performed in a reactor through which a stream of gas is passed, preferably step (b) is performed under continuous gas flow.

9. A process according to claim 1, wherein step (b) is performed in an oxygen-reduced atmosphere, preferably in an oxygen-free atmosphere.

10. A process according to claim 1, wherein step (b) is performed at atmospheric pressure.

11. A process according to claim 1, characterized in that step (b) lasts for 30-120 min.

12. A process according to claim 1 wherein the cocoa powder recovered in step (d) has an L value which is 1 to 10 points lower than that of the cocoa product of step (a).

13. A process according to claim 1 wherein the cocoa powder recovered in step (d) has a lower a/b value than that of the cocoa product of step (a).

14. A process according to claim 1 wherein the cocoa powder recovered in step (d) has an a/b value which is 0.1 to 1 points lower than that of the cocoa product of step (a).

15. A cocoa powder characterized in that it has:
an L-value of 11 to 17 and an a/b-value of 0.9 to 1.6; and
a pH of 5.5 to 9.0; and
optionally, an ash content of less than 15 FFDM.
